(19) United States
(12) Patent Application Publication
(10) Pub. No.: US 2011/0050419 A1
(43) Pub. Date: Mar. 3, 2011

(54) Remote Intrusion Signaling Security System

(76) Inventors: Kwanyuen Ng, Chino Hills, CA (US); Sarah Seeo Yui Chan Ng, Chino Hills, CA (US)

(21) Appl. No.: 12/547,915

(22) Filed: Aug. 26, 2009

(51) Int. Cl. G08B 13/00

(52) U.S. Cl. 340/542

(57) ABSTRACT

The present invention discloses a novel system for signaling intrusion of a protected space to a remotely located user. The system includes a lock mechanism and a sensor module that detects an unlocked state of the lock mechanism and in response sends out a signal to a central unit. The central unit then communicates to a remote device that indicates intrusion upon receiving the signal. The central unit and the remote device can be incorporated into one unitary system. Alternatively, the central unit can be integrated within the lock mechanism.

### BACKGROUND OF THE INVENTION

The present invention relates to a method, device, apparatus, and system for detecting intrusion and/or unlocking without authorization, and in response, informing a user of the intrusion and/or unauthorized unlocking.

Forced entries to residences, commercial premises, vehicles, etc. are a common problem in both cities and suburban areas. Conventional security systems attempt to address this problem by interlinking entries or security locks of a space intended to be protected with an alarm station; upon detection of any tampering with the entries or locks, sensors therein will activate an audible or visible alarm designed to deter intruders. This conventional technology has been implemented in SkyLink® AA-433 Audio Alarm, for instance.

Such security systems, though posing on the spot deterrence to the intruders, nevertheless suffer from the disadvantage of failing to immediately alert the user when he or she is not in close proximity to the protected space. Also, such systems are less effective in more remote areas. If the alarm station is installed in a readily visible location outside of the protected area, savvy intruders can often sabotage or disarm the alarm system before attempting to enter.

Furthermore, most typical security systems automatically reset the alarm to an original state after the alarm goes off for a period of time. Absent any indication of intrusion record, that approach fails to inform the user when or even whether an intrusion has taken place, let alone which entry of the protected place was tampered with.

### SUMMARY OF THE INVENTION

Given the above deficiencies of the conventional techniques there exists a need for an improved security system that will promptly alert a remotely located user of tampering in a protected area. The alerted user can then take timely necessary measures to prevent actual intrusion and even more serious crimes. For instance, the user may promptly report to the law enforcement or security guards to stop or trace the suspect upon notification by the system. The user can also avoid returning to the intruded-to premise without any heads-up of potential danger, thus endangering her own safety. It is also an object for an improved system to inform the user of an exact entry that was tampered with, provided a plurality of entries or locks are involved in the system.

According to one embodiment, the present invention comprises a system having a lock mechanism to secure entries of a protected area. The system includes a sensor module that detects unlocking or tampering and in response sends out a signal to a central unit. The central unit then communicates to a remote device that indicates intrusion upon receiving the signal. The central unit and the remote device can be incorporated into one unitary system. Alternatively, the central unit can be integrated within the lock mechanism.

The innovative system may also provide a plurality of lock mechanisms and respective sensor modules for detecting attempted entries; upon signaling by any of the sensor modules, the central unit is capable of identifying which lock mechanism is unlocked and informing the remote device of such.

Preferably, the lock mechanism of the inventive system includes a padlock. The padlock typically encompasses a padlock body and a shackle with two integral leg portions slidably receivable through a first and a second bores of the padlock body. In the course of shackle sliding, a latch member slidably mounted in a horizontal passage within the padlock body secures and releases the shackle's first leg portion. In correspondence, a spring member disposed to abut the second leg portion is compressed and decompressed. The sensor module in such embodiment is connected to the spring member and capable of detecting pressure variance transferred from the spring member.

In a first aspect, the sensor module used in the inventive system includes one of the following sensors: motion sensor, break-beam optical sensor, and pressure sensor.

In another aspect, the central unit disclosed herein comprises a receiver interface, a transmitter interface, and an antenna coupled thereto for receiving and transmitting signals. The central unit further comprises a microcontroller for processing the received signals based on rules and data retained in a memory. The microcontroller in can be a microprocessor. A rechargeable battery can be provided to charge the foregoing components of the central unit.

In yet another aspect, the remote device comprises an input device, a speaker, a LCD module, a radio module in connection with an antenna, and a microcontroller. The LCD module displays information to the user, and can include a touch-sensitive panel for receiving user input. The microcontroller may be replaced with a microcomputer. In addition, the remote device can be incorporated into pagers or cellular phones. The remote device may include control functions, such as activating power of the central unit.

The inventive system according to one embodiment further comprises a speaker module to intimidate the intruder. The speaker module includes a wireless receiver for receiving a signal from the central unit, an amplifier to magnify the signal for producing sound, and a loudspeaker to produce the sound.

These and other features and advantages of this invention will become further apparent from the detailed description and accompanying figures that follow. In the figures and description, numerals indicate the various features of the invention, and like numerals refer to like features throughout both the drawings and the description.

### BRIEF DESCRIPTION OF THE DRAWINGS

FIG. 1 is a schematic diagram illustrating an intrusion signaling system according to one embodiment of the present invention.

FIGS. 2A-2C provide sectional views of a padlock in locked, unlocked and broken states, respectively.

FIG. 3 is an exploded perspective view of an embodiment of the sensor module used within the padlock.

FIG. 4 provides a block diagram illustrating a central unit in accordance with the inventive system.

FIG. 5 depicts an internal architecture of a remote device in block diagram form.

### DETAILED DESCRIPTION OF THE PREFERRED EMBODIMENT(S)

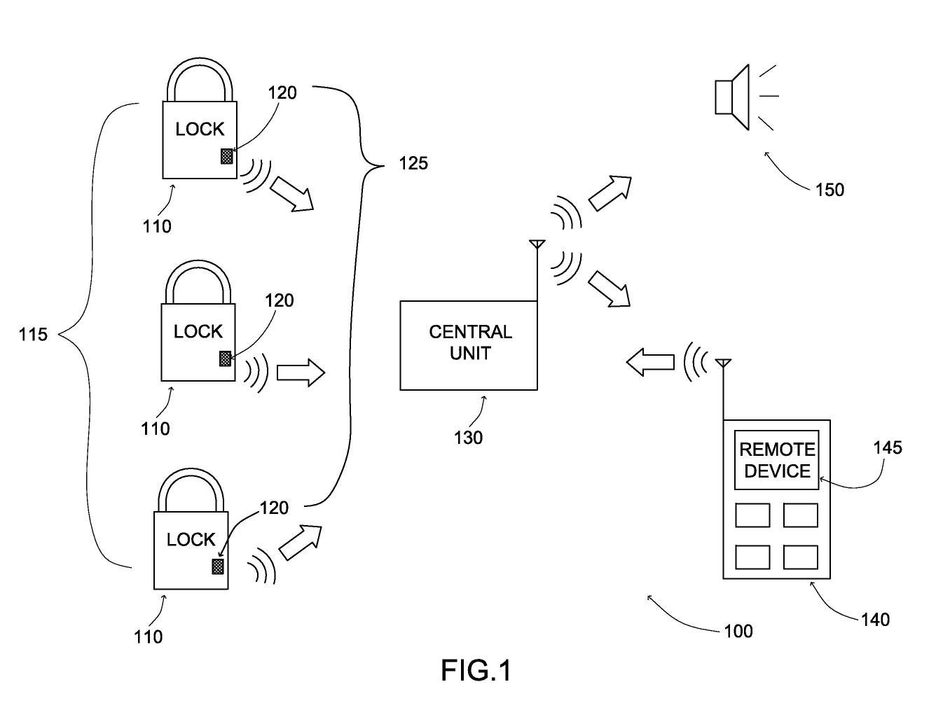

FIG. 1 is a schematic diagram illustrating an intrusion signaling system 100 in accordance with the present invention disclosed herein. The intrusion signaling system 100 can be installed in residences, commercial premises, vehicles, etc. for verifying the secured location's integrity.

The intrusion signaling system 100 is comprised of one or more lock mechanisms 110, a sensor module 120, a central unit 130, a remote device 140, and a speaker module 150. The sensor module 120 is disposed in proximity to the lock mechanism 110 and capable of detecting unauthorized unlocking and/or breaking of the lock mechanism 110. Upon such detection, a signal is transmitted by the sensor module 120 to the central unit 130, which in turn processes the received signal and communicates with the remote device 140. The remote device 140 alerts its user of possible intrusion with an alarm or a visual indication. The central unit 130 can also send a signal to the speaker module 150 preferably nearby the secured place, resulting in noise to intimidate the intruder.

The lock mechanism 110 may be any conventional lock, including a padlock, door lock, car lock, lockbox, and the like. A preferred lockbox's structure is disclosed in the U.S. Pat. No. 6,813,912, which is incorporated herein by reference.

When the lock mechanism 110 is unlocked or tampered with, the sensor module 120 is triggered to generate a signal for transmitting to the central unit 130. The sensor module 120 is arranged in proximity to the lock mechanism 110, and preferably encased in the lock mechanism 110 such that the sensor module 120 can immediately and correctly discover attempted breaking of the lock mechanism 110. One advantage of incorporating the sensor module 120 into the lock mechanism 110 is to prevent intruder's sabotaging or disarming the sensor module 120 to circumvent sensor tripping.

Sensors suitable for use within the system 100 include motion sensors, break-beam optical sensors, pressure sensors and the like.

Upon receiving the signal from the sensor module 120, the central unit 130 processes the signal and then signifies the remote device 140. The central unit 130 can be arranged in a distance to the sensor 120 and lock mechanism 110. In some embodiments, the central unit 130 is integrated into the lock mechanism 110 or the remote device 140.

Preferably, the intrusion signaling system 100 has a plurality of lock mechanisms as shown in FIG. 1 (collectively identified by reference numeral 115) and respective sensor modules (collectively identified by reference numeral 125), each having a dedicated address registered with the central unit 130. The central unit 130 identifies the lock mechanism and associated sensor module by using the sensor module's address.

The remote device 140 is designed to be carried by the user of the system 100 and preferably is equipped with a liquid crystal display (hereinafter “LCD”) 145 for presenting information to the user. The information is derived from analysis of data signals received from the central unit 130.

The speaker module 150 can be placed in vicinity, e.g., 2 meters, to the protected space and configured to launch when receiving the signal transmitted by the central unit 130. The speaker module 150 includes a wireless receiver to receive the signal, an amplifier to increase the magnitude of the signal, and a loudspeaker to produce sound by use of the amplified signal. Preferably, the loudspeaker is able to generate alarm or siren approximating 120 to 125 decibels. The speaker module 150 can also be installed in the remote device 140 to alert the user at first time.

The signals that are communicated among the aforementioned components of the system 100 are advantageously carried over radio waves. A cellular phone system, paging system, and other like RF (radio frequency) carriers can be used for implementing the intrusion signaling system 100. In those embodiments the remote device 140 is incorporated into cellular phones and pagers.

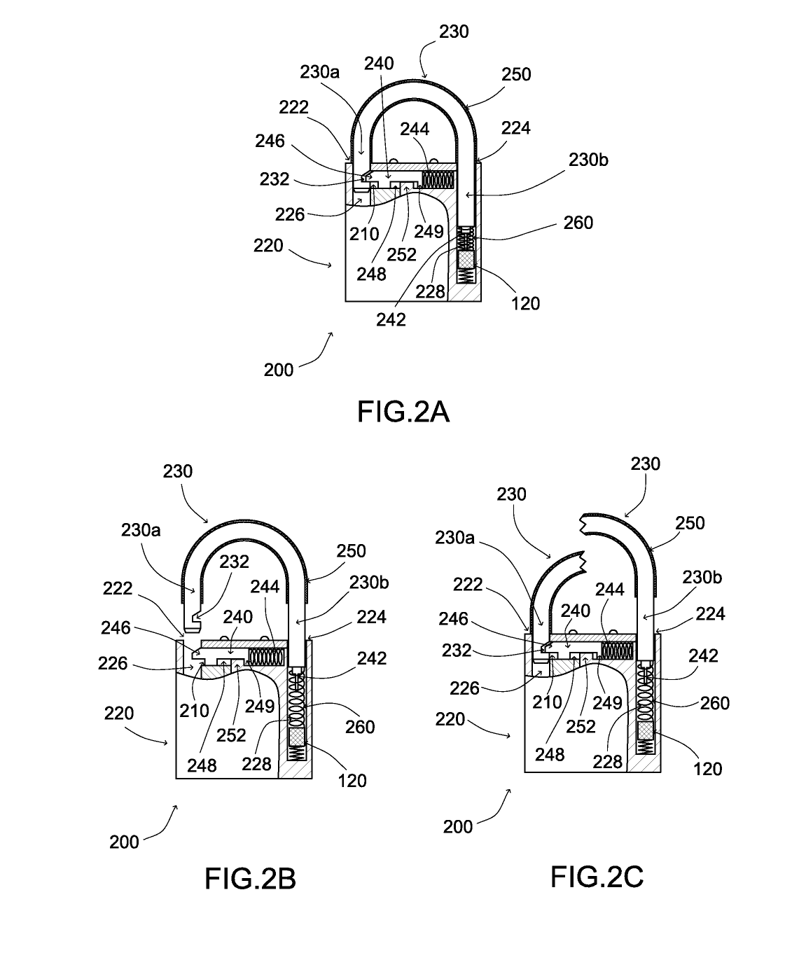

FIGS. 2A-2C illustrate sectional views of a padlock 200 in locked, unlocked and broken states, respectively. Note that the use of terminology such as “vertical” and “horizontal,” “up” and “down,” or variants thereof throughout the specification or claims serves for illustrating the icons' relative positions only and are not intended to limit the present invention in any way.

Referring to FIG. 2A, the padlock 200 includes a padlock body 220 which has two openings 222 and 224 on its top extending inwardly to form two bores 226 and 228. The openings 222 and 224 and bores 226 and 228 are configured to removably receive two integral leg portions 230a and 230b of a shackle 230. The shackle 230 is shaped, e.g., in an inverted U-shape. The two leg portions 230a and 230b can be cylinder-shaped for rotatably mounting into the two bores within the padlock body 220. One leg portion 230b may be longer than the other leg portion 230a to ensure the padlock body 220 retains part of the leg portion 230b in an unlocked position as shown in FIG. 2B. A weatherproof outer sleeve 250 covers and protects the shackle 230. The outer sleeve 250 is preferably made of plastic, resin, or like resilient materials.

The bore 226 communicates with a horizontal passage 210 in which a latch 240 is mounted. The latch 240 can be substantially rectangular-shaped with a chamfered head portion 246, which, under a locked condition, engages in a recess 232 formed within the shackle leg portion 230a. A latch spring 244 is disposed to abut a latch end 249 of the latch 240 in longitudinal alignment, thereby operating to bias the latch 240 outward to engage the recess 232.

A notch 248 is formed in a lower side of the latch 240 to receive an inner end 252 within the body 220 which prevents the latch 240 from sliding off the horizontal passage 228. The inner end 252 is substantially rectangular in over-all configuration. The notch 248 normally has a larger dimension than the inner end 252 in order to allow the latch 240 to move in sideward directions into locking engagement.

When the shackle 230 is in the locked position as illustrated in FIG. 2A, the leg portion 230b is forced further deep in the bore 228 thereby pressing down a vertical spring 260 disposed under the leg portion 230b. The lower end of the leg portion 230b is reduced in diameters as indicated at 242 to form a shoulder against which an upper end of the vertical spring 260 abuts in longitudinal alignment. The reduced end 242 of the leg portion 230b is adapted to securely sit inside of the vertical spring 260. Upon disengaging the leg portion 230a by the latch 240 the vertical spring 260 operates to drive the leg portion 230b upwardly to the unlocked position as shown in FIG. 2B.

Referring to FIG. 2A, the sensor module 120 is disposed under the vertical spring 260 such that when the leg portion 230b is in the locked position and compresses the vertical spring 260, a greater pressure is transferred to the sensor module 120. When the vertical spring 260 is released in the unlocked position as shown in FIG. 2B, the pressure imposed on the sensor module 120 will be detectably reduced, thereby causing the sensor module 120 to generate a signal in response. Likewise, attempted breaking of the padlock 210 such as cutting the shackle 230 as illustrated in FIG. 2C will also release the vertical spring 260 to the unlocked position, thereby triggering the sensor module 120.

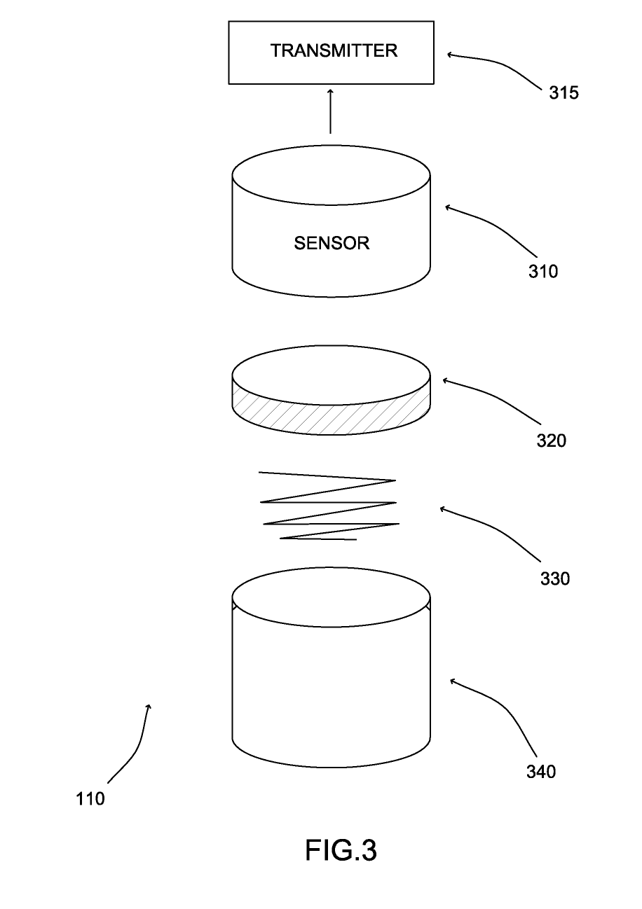

FIG. 3 is an exploded perspective view of an exemplary embodiment of the sensor module 120 used within the padlock 200. The sensor module 120 includes a sensor 310 that is capable of generating a signal as a function of the pressure imposed thereupon. A transmitter 315 is operatively interconnected with the sensor 310 and adapted to receive the signal therefrom. When noticeable pressure reduction is sensed, the transmitter 315 will relay a RF signal that can travel to the central unit 130.

A battery 320 powers the sensor 310 and transmitter 315, and is preferably formed in disk-shape to better fit itself within the compact sensor module 120. The voltage data of the battery 320 may be sent out by the transmitter 315 to the central unit 130 for determining how much electricity remains in the battery 320. A spring 330 is arranged under the battery 320 and the sensor 310 so as to more sensitively transfer variant force to the sensor 310.

As the padlock 200 and the sensor module 120 therein are often located outdoors to secure the protected property, a solid outer cover or shell 340 that can shield the sensor 120 from collision or humidity is provided to better protect the sensor module 120. The solid shell 340 can be made of plastic, metal or the like.

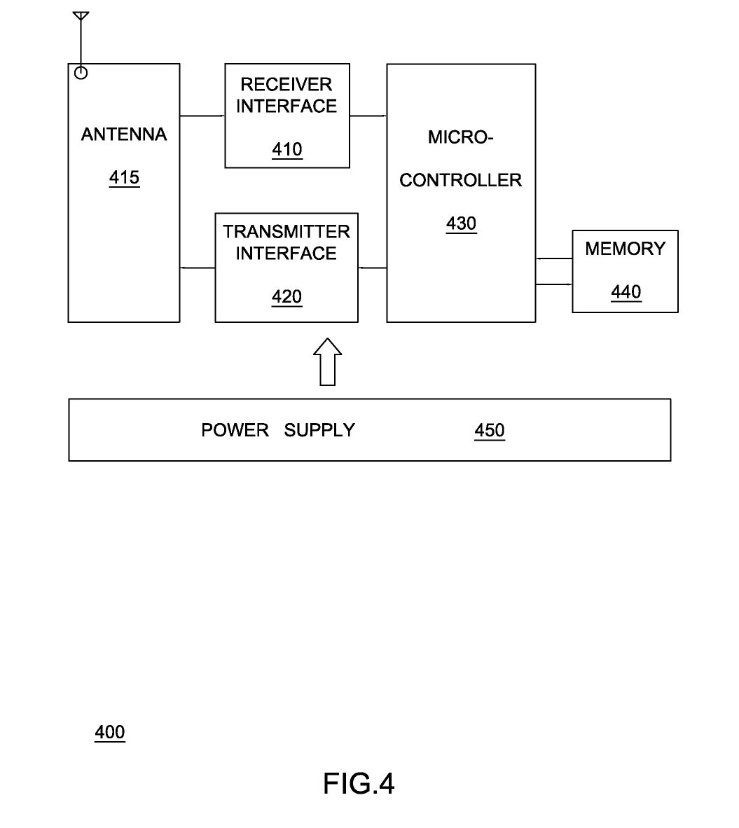

FIG. 4 is a block diagram 400 illustrating the central unit 130 in accordance with the present invention disclosed herein. The central unit 130 is comprised of at least the following components: a receiver interface 410, a transmitter interface 420, a microcontroller 430, a memory 440, and a power supply 450.

The receiver interface 410 is equipped in the central unit 130 to receive signals from either the sensor module 120 or the remote device 140. The transmitter interface 420 is designed to relay to the remote device 140 signals from the central unit 130. A two-way antenna 415, which converts electromagnetic waves to electrical currents and vice versa, may be shared by both the receiver interface 410 and transmitter interface 420.

The microcontroller 430 processes the signal received from the receiver interface 410 and determines, for example, which sensor module of the multiple lock mechanisms produced such signal. As noted above, the sensor modules 125 have their designated addresses registered with the central unit 130. In various embodiments, each of the sensor modules 125 may be tuned to a fixed frequency range, and thus the microcontroller 430 can identify the signaling sensor module by matching the frequency of the received signal with the designated addresses. Those addresses and frequency ranges are retained in a memory 440 comprising a non-volatile memory component such as ROM (read-only-memory) or flash memory. The memory 440 also stores other data and/or rules for retrieval by the microcontroller 430.

In some implementations, the receiver interface 410 is capable of receiving signals carrying requests from the remote device 140 and the microcontroller 430 determines what to respond based on the requests using the data and rules stored in the memory 440. For instance, the remote device 140 can be operated to turn on or off the central unit 130. The microcontroller 430 upon receiving such a signal matches the request to a series of instructions in the memory 440 to provide electricity or shut off the power supply 450. In a similar manner, the microcontroller 430 may also be commanded, for example, to mute the speaker module 150. In correspondence, the microcontroller 430 ceases transmitting signals to launch the speaker module 150.

The power supply 450 provides suitable operating power for the components and can be a rechargeable battery or an adapter connector configured for AC or DC power sources. For example, the power supply 450 may be plugged into a car cigarette lighter receptacle where the central unit is installed in a vehicle.

In some embodiments the central unit 130 is integrated within the lock mechanism 110. As such the sensor module 120 and the central unit may be interconnected by bus, thus eliminating the need to provide the transmitter 315 in the sensor module 120. In other embodiments the central unit 130 is incorporated into the remote device 140, and therefore the transmitter interface 420 can be reduced.

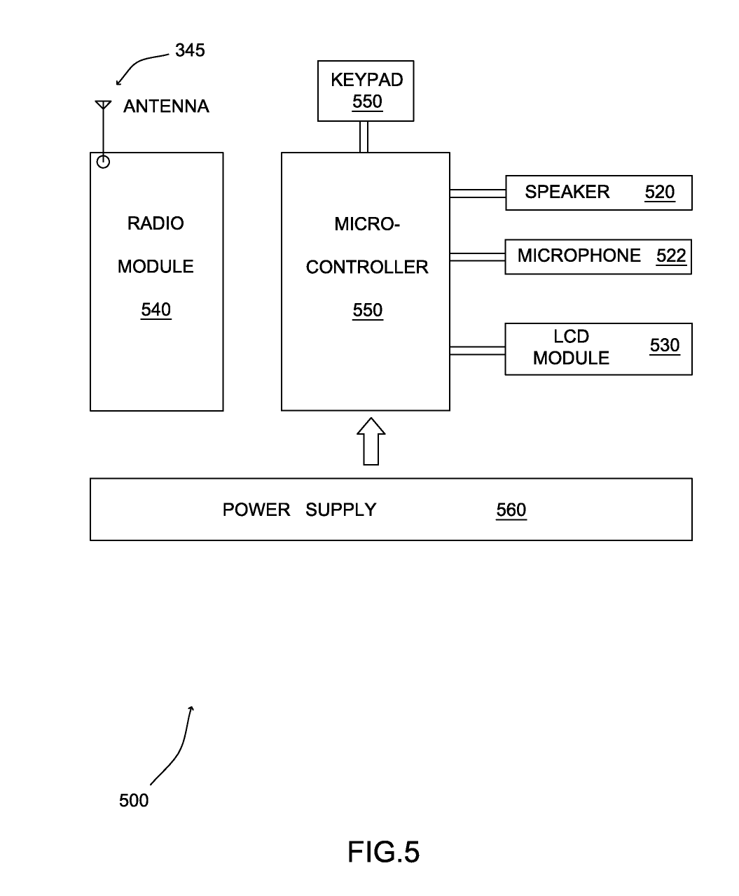

FIG. 5 illustrates an internal architecture 500 of the remote device 140 in block diagram form. The remote device 140 in some embodiments can be integrated in an existing pager or cellular phone model.

A keypad 510 can be actuated by the user to control basic functions of the remote device 140, e.g., powering on and off of the remote device 140, disabling the central unit 130, muting the speaker module 150, etc. A speaker 520 and a microphone 522 may be added to the remote device 140 for producing and receiving audible sound. A LCD module 530 provides a presentation of information such as the lock mechanism's state and the remaining battery percentage of the sensor 310. The LCD module 530 may also comprise a touch-sensitive panel for receiving user input.

A radio module 540 contains components receiving, transmitting, and handling radio frequency signals, and is generally used with an external antenna 545. The external antenna 545 serves to convert the radio frequency signals to electrical currents and vice versa. A microcontroller 550, which may be replaced by a microprocessor and related interfaces in a more complicated structure, serves to process the incoming signals and operates functions associated with the various components shown in FIG. 5. A power supply 560 is attached to the remote device 140 for providing it sufficiently operable power and can be a rechargeable battery pack which requires periodic charging.

Having now described the invention in accordance with the requirements of the patent statutes, those skilled in this art will understand how to make changes and modifications in the present invention to meet their specific requirements or conditions. Such changes and modifications may be made without departing from the scope and spirit of the invention as set forth in the following claims.

What is claimed is:

1. A system for signaling intrusion of a protected space to a remotely located user, the system comprising:
a lock mechanism having a locked state and an unlocked state for securing entries of the protected space;
a sensor module disposed in proximity to the lock mechanism for transmitting a first signal when detecting the unlocked state;
a central unit for receiving the first signal and transmitting a second signal in response; and
a remote device for receiving the second signal transmitted from the central unit, and indicating that the lock mechanism is in the unlocked state.

2. The system of claim 1 further includes a plurality of lock mechanisms and respective sensor modules, wherein the central unit is capable of identifying which lock mechanism is in the unlocked state and informing the remote device of such.

3. The system of claim 1, wherein the lock mechanism includes a padlock, the padlock comprising:
a body;
a shackle removably mounted to the body, wherein the shackle has a first and a second integral leg portions that can be slidably received through a first bore and a second bore formed within the body, respectively;
a latch member slidably mounted in a passage formed within the body communicating at one end with the first bore, the latch member engaging the first leg portion to a first position and releasing the first leg portion to a second position, wherein the first position and the second position correspond to the locked and unlocked states, respectively;
a first spring member disposed in the passage, wherein the first spring member abuts the latch member at one end in longitudinal alignment for biasing the latch member outwardly to engage the first leg portion in the first position; and
a second spring member disposed in the second bore, wherein the second spring member abuts the second leg portion at one end in longitudinal alignment such that the second spring member can be compressed by the second leg portion under the locked state and decompressed under the unlocked state.

4. The system of claim 3, wherein the sensor module is connected to the second spring member and capable of detecting pressure variance transferred from the second spring member between the locked and unlocked states.

5. The system of claim 1, wherein the sensor module comprises:
a sensor;
a transmitter coupled to the sensor for transmitting a signal to the central unit; and
a battery operatively interconnected with the sensor and transmitter for supplying power thereto.

6. The system of claim 5, wherein the sensor includes one of the following:
motion sensor;
break-beam optical sensor; and
pressure sensor.

7. The system of claim 1, wherein the central unit comprises:
a printed circuit board;
a receiver interface coupled to the printed circuit board for receiving signals;
a transmitter interface coupled to the printed circuit board for transmitting a signal in response to the microcontroller's instruction;
an antenna coupled to the printed circuit board and operatively interconnected with the receiver and transmitter interfaces;
a microcontroller coupled to the printed circuit board for processing the received signal and determining what instruction to produce based on the received signal;
a memory coupled to the printed circuit board for retaining data and determining rules for the microcontroller to retrieve; and
a power supply coupled to the printed circuit board for providing operable power to enable the foregoing components.

8. The system of claim 7, wherein the microcontroller is replaced with a microprocessor.

9. The system of claim 7, wherein the power supply includes a rechargeable battery.

10. The system of claim 1, wherein the central unit is integrated within the lock mechanism.

11. The system of claim 1, wherein the central unit is incorporated into the remote device, and the first signal and second signal are one unitary signal.

12. The system of claim 1, wherein the remote device further includes:
a printed circuit board;
an input device coupled to the printed circuit board for receiving user input;
a speaker coupled to the printed circuit board for producing sound;
a LCD module coupled to the printed circuit board for displaying information;
a radio module coupled to the printed circuit board for receiving, transmitting, and handling radio frequency signals;
an antenna coupled to the printed circuit board and operatively interconnected with the radio module;
a microcontroller coupled to the printed circuit board for processing the incoming signal from the central unit and determining what instruction to generate based on the incoming signal; and
a power supply coupled to the printed circuit board for providing operable power to the foregoing components.

13. The system of claim 12, wherein the microcontroller is replaced with a microprocessor.

14. The system of claim 12, wherein the LCD module includes a touch-sensitive panel.

15. The system of claim 1, wherein the remote device includes a pager.

16. The system of claim 1, wherein the remote device includes a cellular phone.

17. The system of claim 12, wherein the power supply includes a rechargeable battery pack.

18. The system of claim 1, wherein the remote device is operable to control powering on and off of the central unit.

19. The system of claim 1 further comprises a speaker module, the speaker module comprising:
a loudspeaker for producing sound;
a wireless receiver coupled to the loudspeaker for receiving a signal generated by the central unit; and
an amplifier coupled to the loudspeaker to increase the amplitude of the signal for use of the loudspeaker; and
a battery operatively interconnected with the loudspeaker, wireless receiver, and amplifier for supplying power thereto.

20. The system of claim 19, wherein the remote device is operable to mute the speaker module.

21. A method for signaling intrusion of a protected space to a remote located user, the method comprising:
transmitting a first signal by a sensor module when detecting an unlocked state of a lock mechanism used to secure entries of the protected space;
receiving the first signal and transmitting a second signal in response by a central unit; and
receiving the second signal transmitted from the central unit by a remote device for indicating that the lock mechanism is in the unlocked state.

22. The method of claim 21, further comprises:
identifying which lock mechanism is in the unlocked state where a plurality of lock mechanisms and respective sensor modules are provided; and
informing the remote device of such.

23. The method of claim 21, further comprising:
receiving a signal from the central unit by a speaker module; and
producing an audible sound correspondingly by the speaker module.

24. The method of claim 21, wherein the central unit is integrated within the lock mechanism.

25. The method of claim 21, wherein the central unit is incorporated into the remote device, and the first signal and second signal are one unitary signal.
